(19) United States
(12) Patent Application Publication
(10) Pub. No.: US 2020/0234224 A1
(43) Pub. Date: Jul. 23, 2020

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventors: Takashige HORI, Aisai-Shi (JP); Makoto AKAHANE, Nagoya-shi (JP); Ken ISHIKAWA, Nagakute-shi (JP); Masatoshi TAKAHARA, Okazaki-shi (JP)

(73) Assignee: TOYOTA JIDOSHA KABUSHIKI KAISHA, Toyota-shi (JP)

(21) Appl. No.: 16/689,615

(22) Filed: Nov. 20, 2019

(30) Foreign Application Priority Data
Jan. 23, 2019 (JP) 2019-009756

(51) Int. Cl. G06Q 10/06; G06K 9/00; B60K 28/06; B60W 40/08

(52) U.S. Cl. CPC G06Q 10/063116; G06Q 10/06312; G06Q 10/063118; B60W 2040/0827; B60K 28/063; B60W 40/08; G06K 9/00845

(57) ABSTRACT

An information processing device according to one embodiment of the present disclosure includes a fatigue level estimation unit configured to estimate a fatigue level of a user based on schedules for the future included in information on schedules of the user.

### INCORPORATION BY REFERENCE

The disclosure of Japanese Patent Application No. 2019-009756 filed on Jan. 23, 2019 including the specification, drawings and abstract is incorporated herein by reference in its entirety.

### BACKGROUND

### 1. Technical Field

The present disclosure relates to an information processing device, an information processing method, and a storage medium.

### 2. Description of Related Art

There is a technique that, with consideration for the fatigue level for each schedule included in the person's schedule information, a schedule is assigned to a free time so that the fatigue level determined by the schedules immediately before and after a schedule-assignable free time becomes relatively low in a daily schedule. (See, for example, Japanese Patent Application Publication No. 2010-140305 (JP 2010-140305 A)).

According to the technique described in JP 2010-140305 A described above, the fatigue level at the end of a day is estimated as the total fatigue level of the schedules of the day.

### SUMMARY

In the meanwhile, when a user performs an operation such as driving a vehicle, it is desirable, from the viewpoint of operability and safety, to know in advance how much fatigue the user has.

However, according to the technique described in JP 2010-140305 A described above, only the fatigue level determined by the user's schedules for the past is considered when estimating how much fatigue the user has. This means that fatigue that will be caused by the preparations for the user's schedules for the future or mental fatigue that will be related to the user's schedules for the future is not considered, sometimes with the result that the fatigue level of the user is not estimated accurately.

The present disclosure provides an information processing device, an information processing method, and a storage medium that can estimate the fatigue level of a user more accurately.

An information processing device according to a first aspect of the disclosure includes a fatigue level estimation unit configured to estimate a fatigue level of a user based on schedules for future included in information on schedules of the user.

According to the above aspect, the information processing device can estimate the fatigue level of the user, considering the physical fatigue that will be caused by the preparations for the user's schedules for the future and the mental fatigue that will be related to the schedules for the future. This allows the information processing device to recognize the fatigue level of the user more accurately.

In the above aspect, the information processing device may further include a schedule information acquisition unit configured to acquire the information on the schedules of the user.

In the above aspect, the fatigue level estimation unit may be configured to estimate the fatigue level of the user based on schedules for past and the schedules for the future included in the information on the schedules.

According to the above configuration, the information processing device can estimate the fatigue level of the user, considering both the fatigue that was caused by the schedules performed in the past and the fatigue that will be caused by the schedules for the future. This allows the information processing device to recognize the fatigue level of the user more accurately.

In the above aspect, the fatigue level estimation unit may be configured to estimate the fatigue level of the user based on at least one of a type of schedule content of each of the schedules for the future within a predetermined period included in the information on the schedules, a time difference between a predetermined time corresponding to the fatigue level to be estimated and a scheduled time, and a type of another participant participating in the schedule.

According to the above configuration, the information processing device can specifically estimate the fatigue level of the user by using the factors that are thought to affect the user's fatigue and are related to the schedules for the future.

In the above aspect, the fatigue level estimation unit may be configured to derive a load degree of each of the schedules for the future within the predetermined period included in the information on the schedules based on the type of the schedule content, the time difference, and the type of the other participant and estimate the fatigue level of the user based on the derived load degree of each of the schedules for the future.

According to the above configuration, the information processing device can more specifically estimate the fatigue level of the user by using the factors that are thought to affect the user's fatigue and that are related to the schedules for the future.

In the above aspect, the fatigue level estimation unit may be configured to estimate a first fatigue level of the user before starting a predetermined operation based on the schedules for the future included in the information on the schedules.

According to the above configuration, the information processing device can recognize the fatigue level (first fatigue level) of the user before starting the predetermined operation.

In the above aspect, the information processing device may further include an alert unit configured to alert the user about the fatigue level through a user terminal before starting the predetermined operation when the first fatigue level is relatively high.

According to the above configuration, the information processing device can alert the user with a relatively high fatigue level before starting the operation, thus improving the safety of the operation.

In the above aspect, the information processing device may further include an alert unit configured to: determine whether the fatigue level of the user is higher than a predetermined criterion; and output alert information to the user via an output device when the fatigue level of the user is higher than the predetermined criterion.

In the above aspect, the user may be a driver of a vehicle, the alert unit may be configured to send control information on the output device to an in-vehicle device mounted on the vehicle when the fatigue level of the user is higher than the predetermined criterion, and the output device may be configured to output the alert information based on the control information.

In the above aspect, the fatigue level estimation unit may be configured to estimate a second fatigue level of the user associated with an execution of the predetermined operation and may estimate the fatigue level of the user at an execution time of the predetermined operation based on the first fatigue level and the second fatigue level.

According to the above configuration, the information processing device can recognize the fatigue level of the user while performing the operation on the assumption that the fatigue level of the user before starting the operation, which is estimated with consideration for the schedules for the future, is taken into consideration.

In the above aspect, the predetermined operation may be the driving of a vehicle.

According to the above configuration, the information processing device can recognize the fatigue level of the user before starting driving the vehicle and the fatigue level of the user while driving the vehicle with consideration for the schedules of the user for the future.

In the above aspect, the information processing device may further include a fatigue reduction unit configured to reduce fatigue of the user using at least one of a visual method through a display unit provided in an interior of the vehicle and an auditory method through a voice output unit provided in the interior of the vehicle, based on a fatigue level while driving the vehicle estimated by the fatigue level estimation unit.

According to the above configuration, when the fatigue level of the user is relatively high, the information processing device can reduce the fatigue of the user by changing the color of the screen of the display unit to a color that is thought to be gentle to the eyes or by outputting background music (BGM), which is thought to be effective in relieving fatigue, from the audio output unit.

An information processing method according to a second aspect of the present disclosure is performed by an information processing device. The information processing method include estimating, by the information processing device, a fatigue level of a user based on schedules for future included in information on schedules of the user.

A non-transitory storage medium stores program causing an information processing device to estimate a fatigue level of a user based on schedules for future included in information on schedules of the user.

According to the aspects described above, the present disclosure can provide the information processing device, the information processing method, and the storage medium that can estimate the fatigue level of the user more accurately.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic diagram showing an example of the configuration of a fatigue estimation system;

FIG. 2A is a diagram showing an example of the hardware configuration of a vehicle;

FIG. 2B is a diagram showing an example of the hardware configuration of a vehicle monitoring server;

FIG. 3 is a functional block diagram showing an example of the functional configuration of the fatigue estimation system;

FIG. 4A is a diagram showing an example of a daily fatigue level estimation method; and

FIG. 4B is a diagram showing an example of a daily fatigue level estimation method.

### DETAILED DESCRIPTION OF EMBODIMENTS

Embodiments of the present disclosure will be described below with reference to the drawings.

[Overview of Fatigue Estimation System]

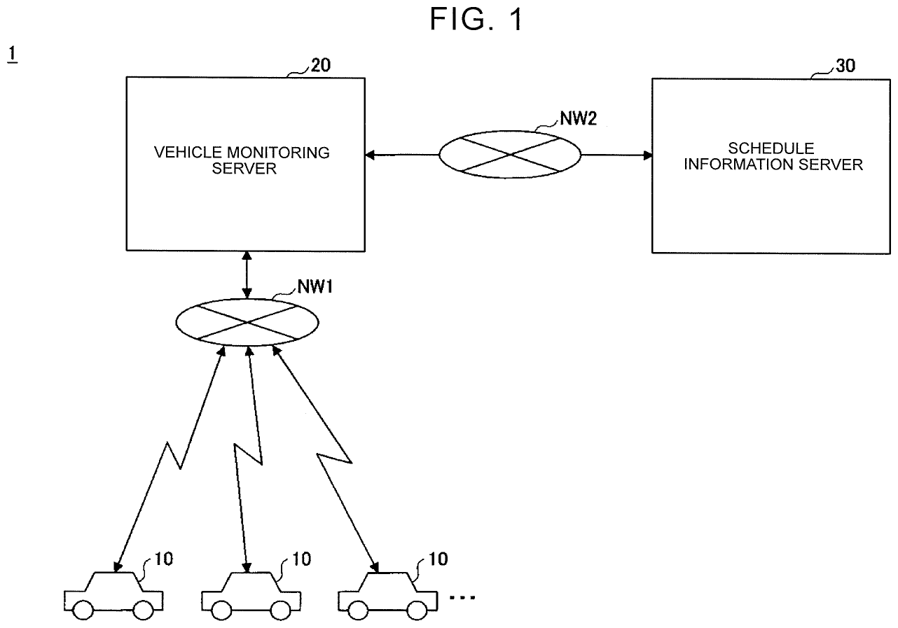

First, with reference to FIG. 1, the outline of the fatigue estimation system 1 according to this embodiment will be described.

The fatigue estimation system 1 includes a plurality of vehicles 10, a vehicle monitoring server 20, and a schedule information server 30.

The fatigue estimation system 1 estimates the fatigue level of each of a plurality of users (hereinafter, “target users”) who use (drive) any of the plurality of the vehicles 10 registered in advance. More specifically, based on the information on the schedules (hereinafter, “schedule information”) of a target user registered in the schedule information server 30, the vehicle monitoring server 20 estimates the fatigue level of the target user before starting and while driving the vehicle 10. In some cases, two or more target users who use the certain vehicle 10 may be registered. In addition, based on the estimated fatigue level of the target user, the fatigue estimation system 1 alerts the target user (driver) of the vehicle 10 about the fatigue level before starting driving the vehicle 10, or reduces the fatigue of the target user (driver) while driving the vehicle 10, through an in-vehicle device of the vehicle 10. In the description of this embodiment, the target user means a user of the vehicle 10 who is the driver of the vehicle 10. In the description of this embodiment, it is also assumed that every target user, that is, the user of the vehicle 10, is a user who uses the online scheduler function, provided by the schedule information server 30, through a predetermined user terminal.

The vehicle 10 is communicably connected to the vehicle monitoring server 20 through a communication network NW1. This communication network NW1 may include a mobile communication network having base stations at its end points, a satellite communication network using communication satellites moving around the earth, and the Internet.

The vehicle 10 acquires predetermined types of dynamic information (hereinafter referred to as “vehicle information”) related to the vehicle 10 (the host vehicle). The vehicle 10 uploads (sends) the acquired vehicle information to the vehicle monitoring server 20 either in response to a command from the vehicle monitoring server 20 or automatically according to a predetermined time. The vehicle information may include the information related to the various states of the vehicle 10 (hereinafter, “vehicle state information”); for example, the vehicle state information includes the information related to the position state, motion state, operation state performed by a driver, and control state. In addition, the vehicle information may include the information related to the state (for example, mood, physical condition, drowsiness, etc.) of the driver (target user) in the vehicle 10 (hereinafter, “user state information”); for example, the user state information includes the image captured by the vehicle interior camera that captures the vehicle interior of the vehicle 10 and the detection information detected by the line of sight sensor that detects the line of sight of the driver (target user) in the vehicle interior. In addition, the vehicle information may include the information related to the environmental state around the vehicle 10 (hereinafter, “environmental state information”); for example, the environmental state information includes the ambient temperature around the vehicle 10 detected by the temperature sensor and the rainfall condition (more specifically, presence of raindrops and their amount) around the vehicle 10 detected by the rain sensor.

The vehicle 10 alerts a driver (target user) in the vehicle about the fatigue level, or tries to reduce fatigue, through a predetermined in-vehicle device under the control of the vehicle monitoring server 20.

The vehicle monitoring server 20 is communicably connected to each of the plurality of the vehicles 10 through the communication network NW1. Furthermore, the vehicle monitoring server 20 is communicably connected to the schedule information server 30 through a communication network NW2 that may include, for example, the Internet.

The vehicle monitoring server 20 receives the vehicle information from each of the plurality of the vehicles 10 through the communication network NW1, and accumulates the received vehicle information on each of the vehicles 10. In addition, the vehicle monitoring server 20 acquires (receives) the schedule information on each of the plurality of target users from the schedule information server 30 through the communication network NW2. Then, for each of the plurality of target users, the vehicle monitoring server 20 estimates the fatigue level of the target user before starting driving the vehicle 10, and the fatigue level of the target user while driving the vehicle 10, based on the vehicle information on the vehicle 10 used by the target user and on the schedule information on the target user.

The schedule information server 30 provides the online scheduler function to the plurality of target users through predetermined user terminals as described above. The user terminal is, for example, a mobile terminal such as a smartphone, a mobile phone, a tablet terminal, and a laptop computer. The user terminal may also be a stationary terminal such as a desktop computer. The user terminal may also be a terminal mounted on the vehicle 10, that is, an in-vehicle device (for example, a navigation device or the head unit of an audio device 16 that will be described later). More specifically, the schedule information server 30 manages the target user's schedule information (also referred to as “schedule information”) registered through a user terminal. More specifically, when the target user performs an operation through a predetermined application program (hereinafter, “scheduler application”) installed in the user terminal, the schedule information server 30 registers the target user's schedule or displays the target user's schedule information on the user terminal.

The scheduler function provided by the schedule information server 30 may be available to persons other than the target user, that is, persons other than the user of the vehicle 10.

[Configuration of Fatigue Estimation System]

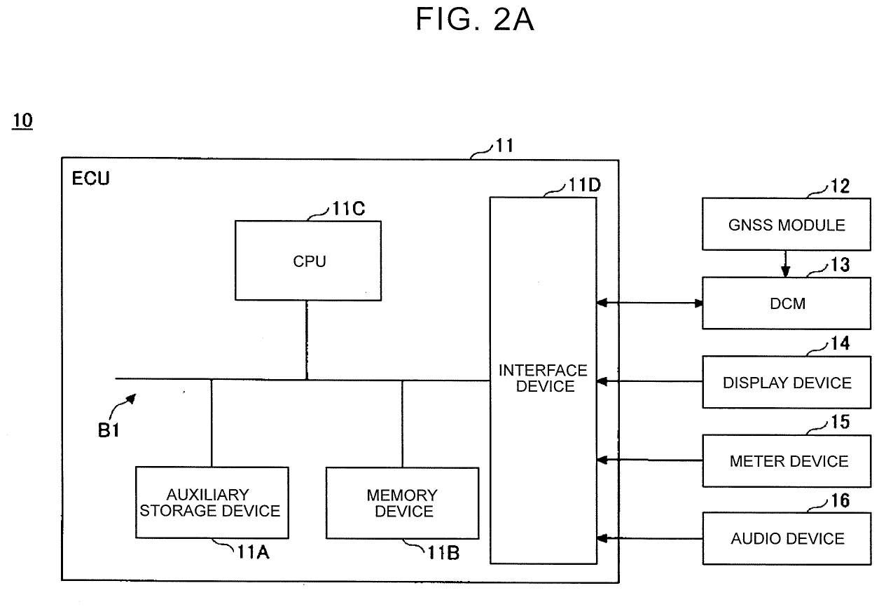

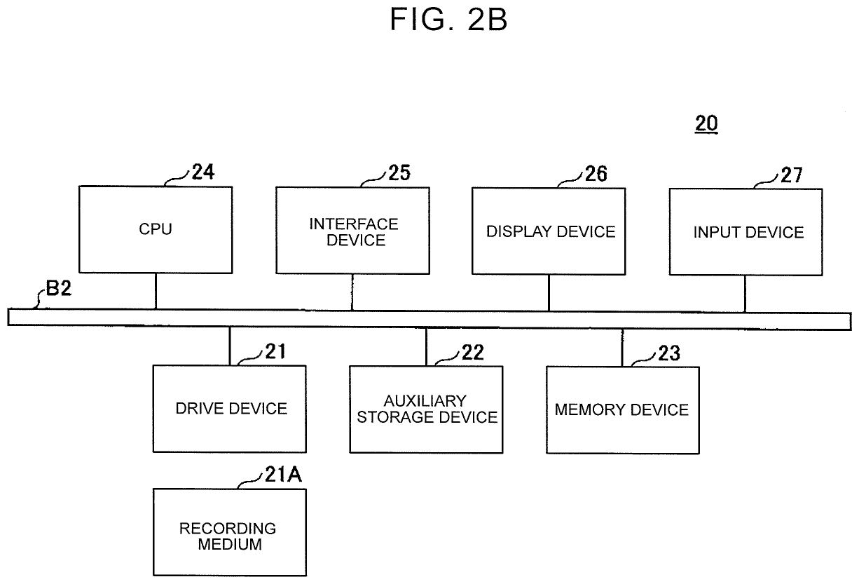

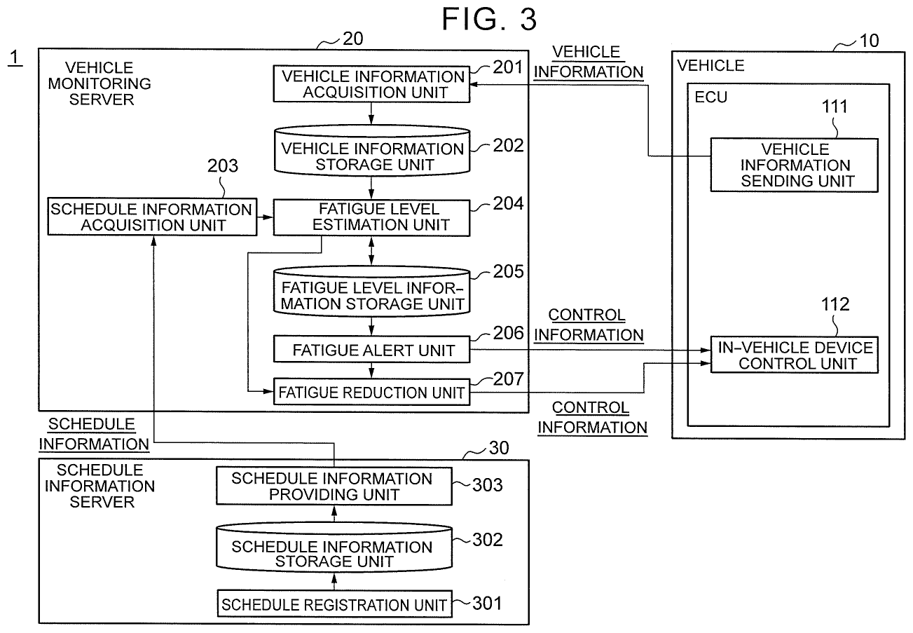

Next, a configuration of the fatigue estimation system 1 will be described below with reference FIG. 1 as well as to FIG. 2A and FIG. 2B and FIG. 3.

FIG. 2A and FIG. 2B are diagrams showing an example of a hardware configuration of the fatigue estimation system 1. More specifically, FIG. 2A is a diagram showing an example of the hardware configuration of the vehicle 10, and FIG. 2B is a diagram showing an example of the hardware configuration of the vehicle monitoring server 20. FIG. 3 is a functional block diagram showing an example of the functional configuration of the fatigue estimation system 1.

The hardware configuration of the schedule information server 30 is substantially the same as that of the vehicle monitoring server 20 and, therefore, in the description below, the hardware configuration of the schedule information server 30 is omitted and described with reference to FIG. 2B. In the description of the schedule information server 30, reference numerals “21”, “21A”, “22”, “23”, “24”, “25”, “26”, “27”, and “B2” in FIG. 2B are replaced, respectively, by “31”, “31A”, “32”, “33”, “34”, “35”, “36”, “37” and “B3”.

<Configuration of vehicle> As shown in FIG. 2A, the vehicle 10 includes an ECU 11, a global navigation satellite system (GNSS) module 12, a data communication module (DCM) 13, a display device 14, a meter device 15, and an audio device 16.

The ECU 11, which is an electronic control unit that performs various types of control processing for the vehicle 10, may have its function implemented by any hardware or a combination of hardware and software. For example, the ECU 11 may be configured by a microcomputer that includes an auxiliary storage device 11A, a memory device 11B, a central processing unit (CPU) 11C, and an interface device 11D. These components are interconnected by a bus B1.

The program for implementing the various functions of the ECU 11 is provided by a dedicated tool connected, via a detachable cable, to a predetermined external connection connector (for example, data link coupler (DLC)) connected to an in-vehicle network such as controller area network (CAN) of the vehicle 10. When a predetermined operation is performed on the dedicated tool, the program is installed from the dedicated tool to the auxiliary storage device 11A of the ECU 11 via the cable, the connector, and the in-vehicle network. The program may also be downloaded from another computer (for example, the vehicle monitoring server 20) through the communication network NW1 for installation to the auxiliary storage device 11A.

The auxiliary storage device 11A is a non-volatile storage unit that stores installed programs as well as necessary files and data. The auxiliary storage device 11A is, for example, a hard disk drive (HDD), a flash memory, or the like.

The memory device 11B reads a program from the auxiliary storage device 11A into itself when a program start instruction is received.

The CPU 11C executes a program stored in the memory device 11B to implement various functions of the ECU 11 according to the program.

The interface device 11D is used, for example, as an interface for connection to the in-vehicle network or for one-to-one connection to various sensors, actuators, and the like. The interface device 11D may include a plurality of different types of interface devices according to devices to be connected.

The GNSS module 12 receives satellite signals sent from three or more, preferably four or more, satellites above the vehicle 10 and, based on the received signal, determines the position of the vehicle 10 (host vehicle) on which the GNSS module 12 is mounted. The positioning information output by the GNSS module 12, that is, the position information on the vehicle 10, is sent to the DCM 13 through, for example, a one-to-one communication line or the in-vehicle network. The positioning information output by the GNSS module 12 may also be sent from the DCM 13 to the ECU 11 through, for example, the in-vehicle network.

The DCM 13 is an example of a communication device that connects to the communication network NW1 outside the vehicle 10 for communication with an external device, including the vehicle monitoring server 20, through the communication network NW1. The DCM 13 sends and receives various signals (for example, an information signal, a control signal, and the like) to and from the vehicle monitoring server 20. Furthermore, the DCM 13 is communicably connected to the ECU 11 through a one-to-one communication line or an in-vehicle network such as CAN. In response to a request from the ECU 11, the DCM 13 sends various signals to the outside of the vehicle 10 (host vehicle) or outputs the signal, received from the outside of the vehicle 10, to the ECU 11.

The display device 14 (an example of a display unit) displays various information images. For example, the display device 14 may display the route guidance screen output by the navigation device mounted on the vehicle 10.

The meter device 15 (an example of a display unit) displays the information indicated by various instruments mounted on the vehicle 10 (for example, speedometer, tachometer, odometer, fuel level indicator, shift position, etc.) and the notification information based on the information indicated by various instruments (for example, warning light etc.).

The audio device 16 (an example of a voice output unit) outputs the voice information, output from a predetermined sound source, from the speaker in the vehicle interior of the vehicle 10.

Next, the functional configuration of the vehicle 10 will be described. As shown in FIG. 3, the ECU 11 includes a vehicle information sending unit 111 and an in-vehicle device control unit 112 as the functional units. These functional units are implemented by executing one or more programs, installed in the auxiliary storage device 11A, on the CPU 11C.

The vehicle information sending unit 111 acquires, or causes the DCM 13 to acquire, the predetermined types of vehicle information at a predetermined interval (for example, at an interval of several tens of seconds to several minutes) and sends the acquired vehicle information to the vehicle monitoring server 20 through the DCM 13. The vehicle information sending unit 111 sends the following various types of vehicle information to the vehicle monitoring server 20. The vehicle information to be sent to the vehicle monitoring server 20 may include the position information on the vehicle 10 positioned by the GNSS module 13. The vehicle information to be sent to the vehicle monitoring server 20 may also include the user state information. The vehicle information to be sent to the vehicle monitoring server 20 may also include the information on the state of driving operation of the vehicle 10 performed by the driver (hereinafter, “driving operation information”). The “driving operation” refers to an action performed by the driver to autonomously operate the “travel”, “turn”, and “stop” functions of the vehicle 10. More specifically, the driving operation includes the operation of the accelerator pedal or an alternative operation unit, the operation of the steering wheel or an alternative operation unit, and the operation of the brake pedal or an alternative operation unit. The vehicle information to be sent to the vehicle monitoring server 20 may also include the information on the operation state of an in-vehicle device (for example, an air conditioner or a navigation device in the vehicle interior) other than the information on the driving operation state of the vehicle 10 (hereinafter, “in-vehicle device operation information”). The vehicle information to be sent to the vehicle monitoring server 20 may also include the image information captured by the camera in the vehicle interior of the vehicle 10. The vehicle information to be sent to the vehicle monitoring server 20 may also include the information on the on/off state of any of the various warning lights on the meter device 15, including the warning light indicating that the remaining amount of gasoline is very low (hereinafter, “warning light information”). The vehicle information to be sent to the vehicle monitoring server 20 may also include the information on the setting state (for example, the destination that is set) of the navigation device of the vehicle 10 (hereinafter, “navigation setting information”). The vehicle information to be sent to the vehicle monitoring server 20 may also include the information on the road surface condition (hereinafter, “road surface condition information”) such as the information on the friction coefficient of the road surface derived from the detection information on the wheel speeds of the driving wheels and the driven wheels detected by the wheel speed sensor and the information on the road surface gradient derived from the detection information on the acceleration sensor. The vehicle information to be sent to the vehicle monitoring server 20 may also include the image information captured by an in-vehicle camera that captures the area around the vehicle 10. The various types of vehicle information described above are sent to the vehicle monitoring server 20. More specifically, the vehicle information sending unit 111 may send the signal to the vehicle monitoring server 20. This signal includes (1) the identification information that identifies the vehicle 10 that is the sending source (for example, vehicle identification number (VIN) of the vehicle 10 or the vehicle identifier (ID) specified in advance for each of the plurality of vehicles 10) (hereinafter “vehicle identification information”), (2) the information on the acquisition date/time of the vehicle information (for example, time stamp) (hereinafter “acquisition date/time information”), and (3) the vehicle information. This signal allows the vehicle monitoring server 20 to identify (specify) the vehicle 10 that is the sending source of the signal that includes the vehicle information or to identify the acquisition date/time (acquisition time) of the vehicle information.

The function of the vehicle information sending unit 111 may be transferred to the DCM 13.

The in-vehicle device control unit 112 controls the in-vehicle devices (e.g., the display device 14, the meter device 15, the audio device 16, etc.) under the control of the vehicle monitoring server 20.

<Configuration of vehicle monitoring server> The vehicle monitoring server 20 may have its functions implemented by any hardware or a combination of hardware and software. As shown in FIG. 2B, the vehicle monitoring server 20 includes a drive device 21, an auxiliary storage device 22, a memory device 23, a CPU 24, an interface device 25, a display device 26, and an input device 27. These devices are connected to each other via a bus B2.

The programs for implementing the various functions of the vehicle monitoring server 20 are provided by a portable recording medium 21A such as a compact disc read only memory (CD-ROM), a digital versatile disc read only memory (DVD-ROM), or a universal serial bus (USB) memory. When the recording medium 21A in which the program is recorded is set on the drive device 21, the program is installed from the recording medium 21A to the auxiliary storage device 22 via the drive device 21. The program may also be downloaded from another computer via a communication network for installation to the auxiliary storage device 22.

The auxiliary storage device 22 stores various installed programs as well as necessary files and data.

The memory device 23 reads a program from the auxiliary storage device 22 into itself when a program start instruction is received.

The CPU 24 executes a program stored in the memory device 23 to implement various functions of the vehicle monitoring server 20 according to the program.

The interface device 25 is used as an interface for connection to a communication network (for example, communication networks NW1, NW2).

The display device 26 displays the graphical user interface (GUI) according to a program executed by the CPU 24.

The input device 27 is used by an operator or an administrator of the vehicle monitoring server 20 to enter various operation instructions related to the vehicle monitoring server 20.

Next, the functional configuration of the vehicle monitoring server 20 will be described. As shown in FIG. 3, the vehicle monitoring server 20 includes a vehicle information acquisition unit 201, a schedule information acquisition unit 203, a fatigue level estimation unit 204, a fatigue alert unit 206, and a fatigue reduction unit 207 as the functional units. These functional units are implemented by executing one or more programs, installed in the auxiliary storage device 22, on the CPU 24. In addition, the vehicle monitoring server 20 uses a vehicle information storage unit 202 and a fatigue level information storage unit 205. The vehicle information storage unit 202 and the fatigue level information storage unit 205 can be implemented using, for example, the auxiliary storage device 22 or an external storage device communicably connected to the vehicle monitoring server 20.

The vehicle information acquisition unit 201 acquires the vehicle information included in the signal received from each of the plurality of the vehicles 10 and stores (accumulates) the received vehicle information in the vehicle information storage unit 202. More specifically, the vehicle information acquisition unit 201 stores the vehicle information, received from the vehicle 10, in the vehicle information storage unit 202 as a record. In this record, the vehicle information is associated with the corresponding vehicle identification information and the acquisition date/time information.

The vehicle information storage unit 202 stores the vehicle information, received from the vehicle 10 as described above. More specifically, the vehicle information storage unit 202 may accumulate records, each of which includes the vehicle identification information, acquisition date/time information, and vehicle information. In this way, the vehicle information storage unit 202 may holds a group of records (that is, a database) of the vehicle information acquired by a plurality of the vehicles 10. In addition, the vehicle information storage unit 202 may have a vehicle information storage unit dedicated to each of the plurality of the vehicles 10. In this case, each vehicle information storage unit may include a history of records (that is, a group of records) each including the acquisition date/time information and the vehicle information for each of the vehicles 10.

The schedule information acquisition unit 203 acquires the schedule information on each of a plurality of target users from the schedule information server 30. In this case, when there are two or more target users as the driver of the vehicle 10, the schedule information acquisition unit 203 may acquire the schedule information on all the users of the vehicle 10. More specifically, the schedule information acquisition unit 203 sends an acquisition request to the schedule information server 30 to acquire the schedule information on each of a plurality of target users from the schedule information server 30. In this case, the schedule information acquisition unit 203 may send an acquisition request at each acquisition time. Instead, the schedule information acquisition unit 203 may send an acquisition request specifying a periodic acquisition time only once to the schedule information server 30, in which case, the schedule information server 30 automatically sends the schedule information to the schedule information acquisition unit 203 at each acquisition time.

The fatigue level estimation unit 204 estimates the fatigue level of each user of the plurality of the vehicles 10. In the description below, the fatigue level is divided into two: daily fatigue level and driving fatigue level.

First, the daily fatigue level will be described. The fatigue level estimation unit 204 estimates the fatigue level of each of the plurality of target users before starting driving the vehicle 10, that is, the fatigue level on a daily basis (hereinafter referred to as “daily fatigue level”) (an example of a first fatigue level), based on the target user's schedule information.

For example, for each of the schedules for the past and the schedules for the future within a predetermined period (for example, within a week before and after the day the target user uses the vehicle 10) included in the schedule information on the target user, the fatigue level estimation unit 204 estimates the degree of load (hereinafter, “load degree”) affecting the fatigue of the target user at the time before starting driving the vehicle 10. In this case, the fatigue level estimation unit 204 may estimate the load degree of each of the schedules for the past and the schedules for the future based on the content of the schedule. This is because the fatigue level of the user can change mentally and physically depending on the content of the schedule. For example, the fatigue level estimation unit 204 may estimate the load degree as follows; first, the fatigue level estimation unit 204 determines the type of the content of the schedule, which is one of a plurality of predetermined types, and then, based on the determined type, assigns the load degree corresponding to the determined type to the schedule. In addition, for each of the schedules for the past and the schedules for the future, the fatigue level estimation unit 204 may estimate the load degree based on the time difference (difference in the number of days) between the current day the target user drives the vehicle 10 and the scheduled day. This is because the smaller the time difference, more likely the influence of a schedule for the past remains as fatigue. This is also because the smaller the time difference, the more likely the physical load of preparation for a schedule for the future and the mental load for a schedule for the future become high. In addition, the fatigue level estimation unit 204 may estimate the load degree for each of the schedules for the past and the schedules for the future, based on whether there is another participant other than the target user and based on the relationship between the target user and the other participant. This is because, the load of the target user is likely to become higher physically and mentally when there is another participant than when there is no other participant. In addition, the load of the target user is likely to become higher when the other participant is a target user's supervisor at work than when the other participant is a target user's family or friend. After considering the load degrees described above, the fatigue level estimation unit 204 estimates the daily fatigue level of the target user based on the estimated load degree of each of the target user's schedules for the past and the schedules for the future.

The fatigue level estimation unit 204 estimates, for each of a plurality of target users, the daily fatigue level before starting driving, on the assumption that the target user drives on the day during a time zone where the usage frequency of the vehicle 10 is low every day (for example, a very early time zone such as 0 o'clock to 4 o'clock) and, then, stores the estimated daily fatigue in the fatigue level information storage unit 205. In this case, when a schedule is registered on the current day, the fatigue level estimation unit 204 may estimate the daily fatigue level of the target user both for the driving before the schedule and for the driving after the schedule on the assumption that the target user will drive before the schedule and after the schedule. In addition, when two or more schedules are registered on the current day, the fatigue level estimation unit 204 may estimate the daily fatigue level of the target user both for the driving before the schedule and for the driving after the schedule for each of the two or more schedules. For example, when two schedules are registered on the current day, the fatigue level estimation unit 204 estimates the daily fatigue level of each of the following three cases: the driving before the first schedule, the driving after the first schedule and before the second schedule, and the driving after the second schedule.

Next, the driving fatigue level will be described. When the target user is driving the vehicle 10, the fatigue level estimation unit 204 estimates the fatigue level of the target user generated by driving the vehicle 10 (hereinafter “driving fatigue level”) (an example of the second fatigue level).

For example, the fatigue level estimation unit 204 may estimate the driving fatigue level of the target user based on the driving operation state of the target user while driving the vehicle 10. In this case, the driving operation state of the target user can be obtained from the vehicle information (driving operation information) on the target user's vehicle 10 stored in the vehicle information storage unit 202. More specifically, the fatigue level estimation unit 204 may estimate the driving fatigue level of the target user based on whether and the number of times the target user performed a sudden driving operation (for example, sudden braking, sudden steering, etc.) while driving the vehicle 10. This is because a sudden driving operation is thought to increase the load of the target user to a relatively large degree, both physically and mentally.

The fatigue level estimation unit 204 may also estimate the driving fatigue level of the target user based on the length of time elapsed from the time the target user started driving the vehicle 10. This is because the driving fatigue level of the target user is thought to increase as the elapsed time from the start of driving of the vehicle 10 becomes longer.

The fatigue level estimation unit 204 may also estimate the driving fatigue level of the target user based on whether and the number of times an operation other than the driving operation was performed while driving the vehicle 10 (for example, an operation performed by the target user for the air conditioner and the navigation device in the vehicle interior). This is because the user's driving fatigue level is thought to become higher when other operations are performed in addition to the driving operation. Note that the information about whether operations other than the driving operation of the vehicle 10 were performed is obtained from the latest vehicle information (in-vehicle device operation information) on the target user's vehicle 10 stored in the vehicle information storage unit 202.

The fatigue level estimation unit 204 may also estimate the mood, physical condition, and drowsiness of the target user while driving the vehicle 10 and, based on the estimated content, estimate the driving fatigue level of the target user. This is because the mood, physical condition, and drowsiness of the target user are thought to affect his or her driving fatigue level. Note that the mood, physical condition, and drowsiness of the target user can be estimated from the vehicle information (user state information) on the target user's vehicle 10 stored in the vehicle information storage unit 202. The fatigue level estimation unit 204 may also estimate the mood, physical condition, and drowsiness of the target user from the sleeping time of the target user on the day before that is estimated from the schedule information on the target user.

The fatigue level estimation unit 204 may also estimate the driving fatigue level of the target user based on whether there is another passenger in the vehicle 10 and based on the relationship between the other passenger and the target user. This is because there may be an additional fatigue of the target user (such as a conversation with another passenger or concern about the condition of another passenger) when there is a passenger rather than when there is no passenger. This is also because there is a high possibility that the mental fatigue level of the target user will become greater when the passenger is a target user's supervisor at work than when the passenger is a target user's family or a friend. Note that the information about whether there is a passenger in the vehicle 10 and who the passenger is may be obtained, for example, based on the schedule information on the target user. The information about whether there is a passenger in the vehicle 10 and who the passenger is may also be obtained based on the vehicle information (image information captured by the camera in the vehicle interior) on the target user's vehicle 10 stored in the vehicle information storage unit 202.

The fatigue level estimation unit 204 may estimate the driving fatigue level based on the time margin for the next schedule while driving the vehicle 10 (for example, the difference between the start time and the predicted arrival time of the schedule when the target user is traveling to the next scheduled location using the vehicle 10). This is because, if the user cannot afford the time, the target user may feel pressed and the mental fatigue level may become high. Note that the next schedule of the target user can be obtained from the schedule information on the target user.

The fatigue level estimation unit 204 may also estimate the driving fatigue level of the target user based on whether there is an abnormality in the vehicle 10 (for example, whether any of the various warning lights in the meter device 15 is on, including the warning light indicating that the remaining amount of gasoline is very low). This is because, when an abnormality occurs in the vehicle 10, it is more likely that the driving fatigue of the target user will become relatively higher due to additional work; for example, the target user must drive while trying to prevent the abnormality in the vehicle 10 from getting worse or while searching for a dealer for inspection. In such a case, there is a possibility that the fatigue level of the target user will become relatively high. Note that the information about whether there is an abnormality in the vehicle 10 may be obtained based on the latest vehicle information (warning light information etc.) on the target user's vehicle 10 stored in the vehicle information storage unit 202.

The fatigue level estimation unit 204 may also estimate the driving fatigue level of the target user based on the information on the destination of the vehicle 10. More specifically, the fatigue level estimation unit 204 may estimate the driving fatigue level of the target user based on whether the road to the destination is congested, based on whether the facilities at the destination have a parking lot and whether the parking lot is congested, and based on the number of times the target user has visited the destination. This is because the driving fatigue level of the target user is thought to become relatively higher as the road to the destination is more congested. This is also because, when there is no parking lot at the destination, the driving fatigue level of the target user is thought to become relatively higher since it is necessary to look for a parking lot; in addition, when there is a parking lot but when the parking lot is congested, the driving fatigue level of the target user is thought to become relatively higher since it takes time to park. This is also because, when the target user has not visited the destination many times, the driving fatigue level of the target user is thought to become relatively higher since the user is not familiar with the moving route and the parking lot. Note that the information on the destination of the vehicle 10 may be obtained from the vehicle information (navigation setting information) on the vehicle 10 stored in the vehicle information storage unit 202. The information on the destination of the vehicle 10 may also be obtained based on the schedule information on the target user. The information on the congestion of the road to the destination of the vehicle 10 may be obtained, for example, based on the road traffic information acquired from an external organization. The information on whether the facilities at the destination of the vehicle 10 have a parking lot and whether the parking lot of the destination of the vehicle 10 is congested may be obtained, for example, from the database of the facilities information stored in advance in the auxiliary storage device 22 or may be obtained from the information in the web page of the facilities. The information on the frequency of target user's visits (the number of visits) to the destination of the vehicle 10 may be obtained based on the schedule for the past included in the schedule information on the target user.

The fatigue level estimation unit 204 may also estimate the driving fatigue level of the target user based on the condition of the road on which the vehicle 10 is traveling (for example, road surface condition, curve frequency and curvature, congestion degree, nighttime brightness, etc.). This is because the driving operation itself and the ease of recognition and determination before the driving operation differ depending on the condition of the road on which the vehicle 10 is traveling. Note that the information on the road on which the vehicle 10 is traveling may be obtained based on the vehicle information (position information) on the target user's vehicle 10 stored in the vehicle information storage unit 202 and based on the road information database stored in advance in the auxiliary storage device 22. The information on the road surface condition of the road may be obtained from the vehicle information (road surface condition information) on the target user's vehicle 10 stored in the vehicle information storage unit 202. The information on the frequency of the curves on the road and their curvatures may be obtained, for example, from the road information database stored in advance in the auxiliary storage device 22. The information on the nighttime brightness of the road may be obtained based on the vehicle information on the target user's vehicle 10 (image information around the vehicle 10) stored in the vehicle information storage unit 202.

The fatigue level estimation unit 204 may estimate the driving fatigue level of the target user at a predetermined time interval (for example, at a several-minute interval) from the time the vehicle 10 is started (ignition on) to the time the vehicle 10 is stopped (ignition off). Then, the fatigue level estimation unit 204 estimates the fatigue level of the target user while driving the vehicle 10 (hereinafter, “driving-time fatigue level”) based on the two types of fatigue levels: one is the daily fatigue level before starting driving the vehicle 10 (that is, the time before the start of the vehicle 10) stored in the fatigue level information storage unit 205 and the other is the driving fatigue level estimated as described above.

The fatigue level information storage unit 205 stores the daily fatigue level of the current day, which is estimated by the fatigue level estimation unit 204 as described above, for each of a plurality of target users.

The fatigue alert unit 206 alerts the target user about the fatigue level of the target user via an in-vehicle device of the vehicle 10 when the daily fatigue level of the target user (that is, fatigue level before starting driving the vehicle 10) is relatively high (more specifically, when the daily fatigue level exceeds the predetermined criterion value). More specifically, when the start (ignition on) of the vehicle 10 is detected, the fatigue alert unit 206 may check the daily fatigue level of the target user corresponding to the vehicle 10 based on the acquisition date/time information that is stored in the vehicle information storage unit 202 and that corresponds to the target user's vehicle 10. Then, when the fatigue alert unit 206 determines that the daily fatigue level exceeds the predetermined criterion value, the fatigue alert unit 206 sends the control information to the vehicle 10 through an in-vehicle device of the vehicle 10 to alert the target user that the fatigue level is relatively high. Thus, when this control information is received, the in-vehicle device control unit 112 controls an in-vehicle device, such as the display device 14 and the audio device 16, and alerts the target user, who is a driver, through voices or visual displays that the fatigue level is relatively high. This alert allows the target user to change the mobility method to another method or to drive the vehicle with more attention than usual while being aware that fatigue level is high.

The fatigue reduction unit 207 reduces the fatigue of the target user through an in-vehicle device of the vehicle 10 when the driving-time fatigue level is relatively high (more specifically, the fatigue level exceeds the predetermined criterion value) between the start and the stop of the vehicle 10. More specifically, when the driving-time fatigue level is relatively high, the fatigue reduction unit 207 sends the control information for reducing the user's fatigue to the vehicle 10 either in the visual method through the display device 14 or the meter device 15 of the vehicle 10 or in the auditory method through the audio device 16. When this control information is received, the in-vehicle device control unit 112 of the vehicle 10 can cause the display device 14 or the meter device 15 to automatically change the color to a color that is thought to be gentle to the eyes. Similarly, the in-vehicle device control unit 112 can cause the audio device 16 to reproduce, as BGM, a genre of audio source that is thought to be effective in relieving fatigue.

<Configuration of schedule information server> As with the vehicle monitoring server 20, the schedule information server 30 may have its function implemented by any hardware or a combination of hardware and software. As shown in FIG. 2B, the schedule information server 30 includes a drive device 31, an auxiliary storage device 32, a memory device 33, a CPU 34, an interface device 35, a display device 36, and an input device 37. These devices are interconnected by a bus B3.

The hardware configuration of the schedule information server 30 is substantially the same as the hardware configuration of the vehicle monitoring server 20, and, therefore, a detailed description will be omitted.

Next, the functional configuration of the schedule information server 30 will be described. As shown in FIG. 3, the schedule information server 30 includes a schedule registration unit 301 and a schedule information providing unit 303 as the functional units. These functional units are implemented by executing one or more programs, installed in the auxiliary storage device 32, on the CPU 34. In addition, the schedule information server 30 uses a schedule information storage unit 302. The schedule information storage unit 302 can be implemented using the auxiliary storage device 32 or an external storage device that is communicably connected to the schedule information server 30.

The schedule registration unit 301 receives a schedule registration request from a predetermined user terminal used by the target user and registers the content of the received request in the schedule information storage unit 302. This request specifies the date and time, the content of the schedule, and the other users who will participate in the schedule. The schedule registration unit 301 registers the information, specified by the request, in the schedule information storage unit 302 as the schedule information on the target user corresponding to the user identification information specified in the request.

The schedule information storage unit 302 registers (stores) therein the schedule information for each of a plurality of target users. More specifically, the schedule information storage unit 302 holds the schedule table database for each of a plurality of target users, with the schedule information on each target user registered in the schedule table database of each target user.

The schedule information providing unit 303 sends the schedule information on each of a plurality of users to the vehicle monitoring server 20 in response to a request from the vehicle monitoring server 20.

### Example of Method for Estimating Daily Fatigue Level

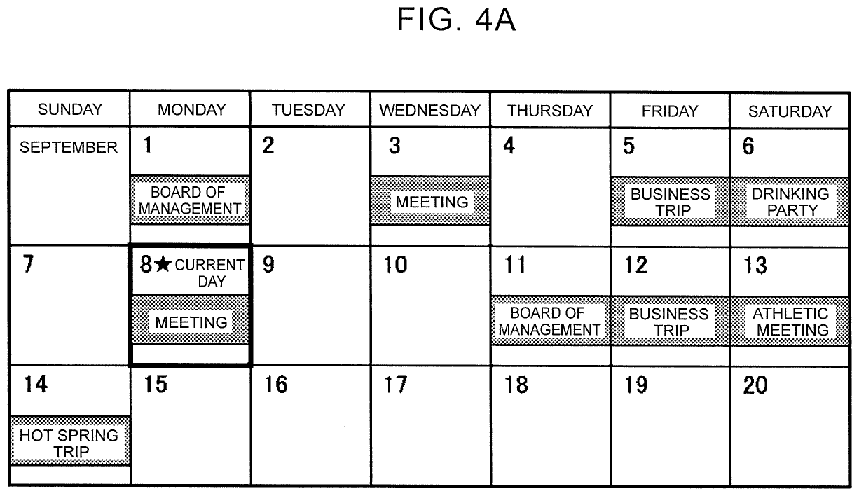

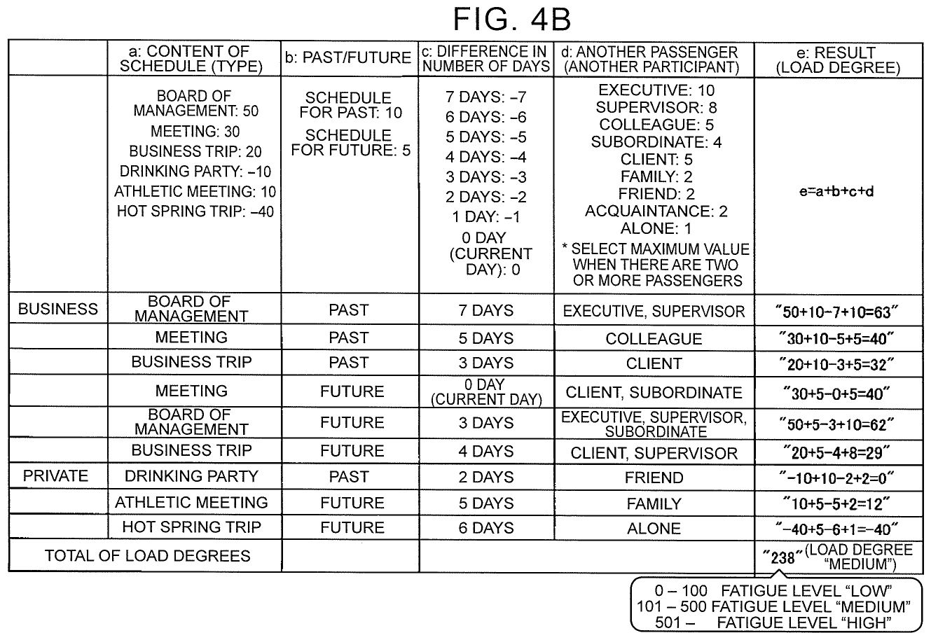

Next, with reference to FIG. 4 (FIG. 4A, FIG. 4B), a specific example of a method used by the vehicle monitoring server 20 for estimating the daily fatigue level of a target user will be described.

FIG. 4A and FIG. 4B are diagrams showing an example of a method used by the vehicle monitoring server 20 for estimating the daily fatigue level of a target user. More specifically, FIG. 4A is a diagram showing an example of the schedule information (schedule table) on the target user. FIG. 4B is a diagram showing an example of the estimation result of the daily fatigue level of the target user estimated by the vehicle monitoring server 20 based on the schedule information shown in FIG. 4A. In the description below, it is assumed that the current day on which the target user is to start driving the vehicle 10 is “September 8”.

In this example, the fatigue level estimation unit 204 estimates the load degree of the schedules for one week before and one week after the current day (September 8). More specifically, the fatigue level estimation unit 204 estimates the load degree of each of the schedules for the past from the current day (September 8) back to a week ago today (September 1) and for the schedules for the future from the current day to a week from today (September 8 to September 14).

As shown in FIG. 4A, “board of management” on September 1, “meeting” on September 3, “business trip” on September 5, and “drinking party” on September 6 are registered as the schedules for the past. In addition, “meeting” on September 8, “board of management” on September 11, “business trip” on September 12, “athletic meeting” on September 13, and “hot spring trip” on September 14 are registered as the schedules for the future. Among them, “board of management” on September 1, “meeting” on September 3, “business trip” on September 5, “meeting” on September 8, “board of management” on September 11, and “business trip” on September 12 are work-related schedules, and “drinking party” on September 6, “athletic meeting” on September 13, and “hot spring trip” on September 14 are personal, private schedules.

As shown in FIG. 4B, the fatigue level estimation unit 204 estimates (calculates) the load degree of each of the schedules for the past and the schedules for the future based on the type of the content of the schedule, whether the schedule is a schedule for the past or a schedule for the future, the difference between the scheduled day and the current day, and the type of other participants participating in the schedule and, then, estimates that the daily fatigue level is the sum of the estimated load degrees.

More specifically, the fatigue level estimation unit 204 calculates the sum of the values each corresponding to the load degree (hereinafter “load degree base value”) assigned, respectively, to the type of the content of the schedule, whether the schedule is a schedule for the past or a schedule for the future, the difference between the scheduled day and the current day, and the type of other participants participating in the schedule. By doing so, the fatigue level estimation unit 204 estimates (calculates) the load degree of each of the schedules for the past and the schedules for the future.

More specifically, for the type of the content of the schedule, the load degree base values of “50”, “30”, “20”, “−10”, “10”, and “−40” are assigned to “board of management”, “meeting”, “business trip”, “drinking party”, “athletic meeting” and “hot spring travel”, respectively. For whether the schedule is a schedule for the past or a schedule for the future, the load degree base values of “10” and “5” are assigned to the schedule for the past and the schedule for the future, respectively. For the difference between the scheduled day and the current day, the load degree base values of “0” to “7” are assigned to the number-of-days difference between the scheduled day and the current day from “0 day” to “7 days”, respectively. For the type of other participants participating in the schedule, the load degree base values of “10”, “8”, “5”, “4”, “5”, “2”, “2”, “2”, and “1” are assigned to “executive”, “supervisor”, “colleague”, “subordinate”, “client”, “family”, “friend”, “acquaintance”, and “no other participant”, respectively. Using these load degree base values, the fatigue level estimation unit 204 can estimate (calculate) the load degree for each of the schedules for the past and the schedules for the future.

After calculating the load degree of each of the schedules for the past and the schedules for the future, the fatigue level estimation unit 204 estimates the daily fatigue level based on the total value of load degrees (=“238”). More specifically, the fatigue level estimation unit 204 classifies the fatigue level of the target user into one of the following three ranks (hereinafter “fatigue degree rank”) based on the total value of fatigue levels: “low” indicating that the fatigue level is relatively low, “medium” indicating that the fatigue level is medium, and “high” indicating that the fatigue level is relatively high. More specifically, when the total value of load degrees is in the range of “0” to “100”, the fatigue level of the target user is classified into the “low” rank. When the total value of load degrees is in the range of “101” to “500”, the fatigue level of the target user is classified into the “medium” rank. When the total value of load degrees is in the range of “501” or higher, the fatigue level of the target user is classified into the “high” rank. Thus, in this example, the fatigue level of the target user is estimated to be the “medium” rank.

For example, the fatigue alert unit 206 (an example of an alert unit) may issue an alert about the fatigue level through an in-vehicle device of the vehicle 10 when the fatigue level of the target user is “medium” or higher. In addition, the fatigue alert unit 206 may have an alert level different between the “medium” rank and the “high” rank. More specifically, when the rank is the “medium” rank, the fatigue alert unit 206 may advise the target user to drive more carefully than usual; on the other hand, when the rank is the “high” rank, the fatigue alert unit 206 may advise the user to use another transportation. This allows the fatigue alert unit 206 to change the mode of alert about the fatigue level according to the fatigue level of the target user.

The fatigue reduction unit 207 may reduce the fatigue of the target user through an in-vehicle device of the vehicle 10 when the fatigue level of the target user is “medium” or higher. In addition, the fatigue reduction unit 207 may reduce fatigue differently between the “medium” rank and the “high” rank. More specifically, when the fatigue level of the target user is the “medium” rank, the fatigue reduction unit 207 may reduce the fatigue by performing only one of the visual method through the display device 14 and the meter device 15 and the auditory method through the audio device 16; on the other hand, when the fatigue level of the target user is the “high” rank, the fatigue reduction unit 207 may reduce the fatigue by performing both methods. This allows the fatigue reduction unit 207 to change the fatigue reduction mode according to the fatigue level of the target user.

### Operation of this Embodiment

Next, the operation of the fatigue estimation system 1 (vehicle monitoring server 20) according to this embodiment will be described.

In this embodiment, the fatigue level estimation unit 204 estimates the fatigue level of the target user based on the schedules for the future included in the schedule information on the target user.

As a result, the vehicle monitoring server 20 can estimate the fatigue level of the target user, considering the physical fatigue that will be caused by the preparations for the target user's schedules for the future and the mental fatigue that will be related to the schedules for the future. This allows the vehicle monitoring server 20 to recognize the fatigue level of the target user more accurately.

In this embodiment, the fatigue level estimation unit 204 may estimate the fatigue level of the target user based on the schedules for the past and the schedules for the future included in the schedule information.

As a result, the vehicle monitoring server 20 can estimate the fatigue level of the target user, considering both the fatigue that was caused by the schedules performed in the past and the fatigue that will be caused by the schedules for the future. This allows the vehicle monitoring server 20 to recognize the fatigue level of the target user more accurately.

The vehicle monitoring server 20 may estimate the fatigue level of the target user using only the schedules for the future instead of using the schedules for the past and the schedules for the future. This is because, in some cases, the fatigue level is thought to be influenced mainly by the target user's schedules for the future, for example, when only the schedules for the future are registered in the schedule information corresponding to the target user or when the target user who was on a long vacation has just returned from the vacation.

In this embodiment, the fatigue level estimation unit 204 may estimate the fatigue level of the target user based on at least one of the following: the type of the content of the schedule for each of the schedules for the future within a predetermined period (for example, within one week before and after the current day) included in the schedule information, the time difference (for example, the number of days) between the predetermined point in time at which the fatigue level is estimated (for example, the current day on which the target user drives the vehicle 10) and the scheduled point in time, and the type of other participants participating in the schedule.

As a result, the vehicle monitoring server 20 can specifically estimate the fatigue level of the target user by using the factors that are thought to affect the target user's fatigue and are related to the schedules for the future.

In this embodiment, the fatigue level estimation unit 204 may derive the load degree of each of the schedules for the future within a predetermined period included in the schedule information based on the type of schedule content, the time difference, and the type of other participants and, based on the derived load degree of each of the schedules for the future, may estimate the fatigue level of the target user.

As a result, the vehicle monitoring server 20 can more specifically estimate the fatigue level of the target user by using the factors that are thought to affect the target user's fatigue and that are related to the schedules for the future.

In this embodiment, the fatigue level estimation unit 204 may estimate the first fatigue level (daily fatigue level) of the target user before starting the predetermined operation (more specifically, before starting driving the vehicle 10) based on the schedules for the future included in the schedule information.

As a result, the vehicle monitoring server 20 can recognize the fatigue level (first fatigue level) of the target user before starting the predetermined operation, that is, before starting driving the vehicle 10.

The predetermined operation may be any operation other than the driving of the vehicle 10. For example, the predetermined operation may include any operation such as the assembly operation at a factory, any operation at a construction site and, in particular, an operation that requires safety. The first fatigue level (daily fatigue level) may be estimated not for the purpose of performing the predetermined operation, for example, the first fatigue level may be estimated for the purpose of simply notifying the target user of the fatigue level.

In this embodiment, when the first fatigue level is relatively high, the fatigue alert unit 206 may alert the target user about the fatigue level through the user terminal before starting the predetermined operation (before starting driving the vehicle 10).

As a result, the vehicle monitoring server 20 can alert the target user with a relatively high fatigue level before starting driving the vehicle 10, thus improving the safety of the vehicle 10.

In this embodiment, the fatigue level estimation unit 204 may estimate the second fatigue level of the user associated with the predetermined operation (the driving fatigue level associated with the driving of the vehicle 10) and, based on both the first fatigue level and the second fatigue level, estimate the fatigue level of the target user when the predetermined operation is performed (while driving the vehicle 10).

As a result, the vehicle monitoring server 20 can recognize the fatigue level of the user while driving the vehicle 10 on the assumption that the fatigue level of the user before starting driving the vehicle 10, which is estimated with consideration for the schedules for the future, is taken into consideration.

In this embodiment, based on the fatigue level while driving the vehicle 10 (driving-time fatigue level) estimated by the fatigue level estimation unit 204, the fatigue reduction unit 207 may reduce the fatigue of the target user using at least one of the visual method and the auditory method. In the visual method, the fatigue is reduced by the display device 14 or the meter device 15 provided in the interior of the vehicle 10. In the auditory method, the fatigue is reduced by the audio device 16 provided in the interior of the vehicle 10.

As a result, when the fatigue level of the target user is relatively high, the vehicle monitoring server 20 can reduce the fatigue of the target user by changing the color of the screen of the display device 14 to a color that is thought to be gentle to the eyes or by outputting BGM, which is thought to be effective in relieving fatigue, from the audio device 16.

While the embodiments of the present disclosure have been described in detail, it is to be understood that the present disclosure is not limited to the embodiments described above. Various changes and modifications may be added within the scope of the present disclosure described in claims.

For example, in the embodiments described above, the function of the vehicle monitoring server 20 and the function of the schedule information server 30 may be integrated into one server device.

In the embodiments and modifications described above, some or all of the functions of the fatigue level estimation unit 204 may be transferred to the outside of the vehicle monitoring server 20. For example, the function of estimating the daily fatigue level, which is one of the functions of the fatigue level estimation unit 204, may be transferred to the schedule information server 30 (an example of an information processing device). Similarly, the function of the fatigue level estimation unit 204 may be transferred to the ECU 11 (an example of the information processing device) of the vehicle 10. In this case, the ECU 11 of the vehicle 10 may communicate with the schedule information server 30, either via the vehicle monitoring server 20 or directly, to acquire the schedule information on the user in the host vehicle from the schedule information server 30. This allows the ECU 11 of the vehicle 10 to estimate the daily fatigue level of the user (driver) in the host vehicle based on the acquired schedule information and to estimate the driving fatigue level based on the vehicle information acquired by the host vehicle.

In the embodiments and modifications described above, the function of the fatigue alert unit 206 and the function of the fatigue reduction unit 207 may be transferred to the ECU 11 of the vehicle 10. In this case, based on the information on the daily fatigue level and the driving-time fatigue level acquired from the vehicle monitoring server 20, the ECU 11 of the vehicle 10 can autonomously alert the user (driver) of the host vehicle about the fatigue level, or reduce the fatigue of the user, through an in-vehicle device of the host vehicle.

What is claimed is:

1. An information processing device comprising a fatigue level estimation unit configured to estimate a fatigue level of a user based on schedules for future included in information on schedules of the user.

2. The information processing device according to claim 1, further comprising a schedule information acquisition unit configured to acquire the information on the schedules of the user.

3. The information processing device according to claim 1, wherein the fatigue level estimation unit is configured to estimate the fatigue level of the user based on schedules for past and the schedules for the future included in the information on the schedules.

4. The information processing device according to claim 1, wherein the fatigue level estimation unit is configured to estimate the fatigue level of the user based on at least one of a type of schedule content of each of the schedules for the future within a predetermined period included in the information on the schedules, a time difference between a predetermined time corresponding to the fatigue level to be estimated and a scheduled time, and a type of another participant participating in the schedule.

5. The information processing device according to claim 4, wherein the fatigue level estimation unit is configured to:
derive a load degree of each of the schedules for the future within the predetermined period included in the information on the schedules based on the type of the schedule content, the time difference, and the type of the other participant; and
estimate the fatigue level of the user based on the derived load degree of each of the schedules for the future.

6. The information processing device according to claim 1, wherein the fatigue level estimation unit is configured to estimate a first fatigue level of the user before starting a predetermined operation based on the schedules for the future included in the information on the schedules.

7. The information processing device according to claim 6, further comprising an alert unit configured to alert the user about the fatigue level through a user terminal before starting the predetermined operation when the first fatigue level is relatively high.

8. The information processing device according to claim 1, further comprising an alert unit configured to:
determine whether the fatigue level of the user is higher than a predetermined criterion; and
output alert information to the user via an output device when the fatigue level of the user is higher than the predetermined criterion.

9. The information processing device according to claim 8, wherein
the user is a driver of a vehicle,
the alert unit is configured to send control information on the output device to an in-vehicle device mounted on the vehicle when the fatigue level of the user is higher than the predetermined criterion, and
the output device is configured to output the alert information based on the control information.

10. The information processing device according to claim 6, wherein the fatigue level estimation unit is configured to:
estimate a second fatigue level of the user associated with an execution of the predetermined operation; and
estimate the fatigue level of the user at an execution time of the predetermined operation based on the first fatigue level and the second fatigue level.

11. The information processing device according to claim 10, wherein the predetermined operation is to drive a vehicle.

12. The information processing device according to claim 11, further comprising a fatigue reduction unit configured to reduce fatigue of the user using at least one of a visual method through a display unit provided in an interior of the vehicle and an auditory method through a voice output unit provided in the interior of the vehicle, based on a fatigue level while driving the vehicle estimated by the fatigue level estimation unit.

13. An information processing method performed by an information processing device, the information processing method comprising estimating, by the information processing device, a fatigue level of a user based on schedules for future included in information on schedules of the user.

14. The information processing method according to claim 13, wherein the fatigue level of the user is estimated based on schedules for past and the schedules for the future included in the information on the schedules.

15. The information processing method according to claim 13, wherein the fatigue level of the user is estimated based on at least one of a type of schedule content of each of the schedules for the future within a predetermined period included in the information on the schedules, a time difference between a predetermined time corresponding to the fatigue level to be estimated and a scheduled time, and a type of another participant participating in the schedule.

16. The information processing method according to claim 13, wherein
the fatigue level is a first fatigue level of the user before starting a predetermined operation, and
the first fatigue level is estimated based on the schedules for the future included in the information on the schedules.

17. A non-transitory storage medium storing a program, wherein the program causes an information processing device to estimate a fatigue level of a user based on schedules for future included in information on schedules of the user.

18. The storage medium according to claim 17, wherein the program causes the information processing device to estimate the fatigue level of the user based on schedules for past and the schedules for the future included in the information on the schedules.

19. The storage medium according to claim 17, wherein the program causes the information processing device to estimate the fatigue level of the user based on at least one of a type of schedule content of each of the schedules for the future within a predetermined period included in the information on the schedules, a time difference between a predetermined time corresponding to the fatigue level to be estimated and a scheduled time, and a type of another participant participating in the schedule.

20. The storage medium according to claim 17, wherein the program causes the information processing device to estimate a first fatigue level of the user before starting a predetermined operation based on the schedules for the future included in the information on the schedules.
